(19) United States
(12) Patent Application Publication
(10) Pub. No.: US 2026/0225363 A1
(43) Pub. Date: Aug. 6, 2026

(54) HIGH-DEFINITION AEROSOL PRINTING USING AN OPTIMIZED AEROSOL DISTRIBUTION AND HYDRODYNAMIC LENS SYSTEM

(71) Applicant: Integrated Deposition Solutions, Inc., Albuquerque, NM (US)

(72) Inventors: David M. Keicher, Albuquerque, NM (US); Marcelino Essien, Albuquerque, NM (US); Stephen Barnes, Albuquerque, NM (US)

(73) Assignee: Integrated Deposition Solutions, Inc., Albuquerque, NM (US)

(21) Appl. No.: 19/152,504

(22) PCT Filed: Feb. 5, 2024
(86) PCT No.: PCT/US2024/014424

§ 371 Date: Jul. 31, 2025

Related U.S. Application Data
(60) Provisional application No. 63/443,442, filed on Feb. 5, 2023.

(51) Int. Cl. B41J 2/03; B41J 2/175; B41J 29/377

(52) U.S. Cl. CPC B41J 2/03; B41J 2/17523; B41J 29/377; B41J 2002/031

(57) ABSTRACT

A printing apparatus is provided that includes a print head, ink cartridge, and temperature regulation element. The print head has a channel and a feed channel; a valve configured to control fluid communication of aerosol gas between the channel and the feed channel; an inverted U-shaped sheath channel defined in the housing through which a sheath gas passes; and a combination chamber at an output of the sheath channel and an output of the feed channel, in which the sheath gas impinges onto the aerosol gas to focus the aerosol gas. The ink cartridge includes a housing defining an internal volume and an outlet that is configured to be in fluid communication the channel of the print head. The internal volume is divided by a cylindrical cap having apertures in a wall thereof and C-shaped shields configured to block the passing of large droplets out of the cap.

### RELATED APPLICATIONS

This application claims priority benefit of U.S. Provisional Application Ser. No. 63/443,442 filed 5 Feb. 2023; the contents of which are hereby incorporated by reference.

### FIELD OF THE INVENTION

The present invention in general relates to aerosol printing, and in particular to devices that use aerosol-based printing to deposit high-density, high-resolution traces on a surface.

### BACKGROUND OF THE INVENTION

Direct Write printing, defined as maskless printing of discreet patterns on a substrate in a one-step process offers many advantages to conventional printing technologies such as lithography and chemical and physical vapor deposition. Indeed, Direct Write processes such as aerosol-based printing are far less expensive to establish and maintain and offer greater flexibility than conventional techniques.

Typically, in aerosol-based printing aerodynamic lenses are used. The use of aerodynamic lenses to focus an aerosol stream is well known as described by Peng Liu, Paul J. Ziemann, David B. Kittelson, and Peter H. McMurry, Generating Particle Beams of Controlled Dimensions and Divergence: I. Theory of Particle Motion in Aerodynamic Lenses and Nozzle Expansions, Aerosol Science and Technology, 22:3, 293-313 (1995). An aerodynamic lens is defined as a flow configuration in which a stream traveling through a cylindrical channel with diameter D is passed through an orifice with diameter d, undergoing one contraction upstream of the orifice and one subsequent and immediate expansion downstream of the orifice. A contraction of an aerosol stream is produced as the flow approaches and passes through the orifice. The gas then undergoes an expansion as the flow propagates downstream into a wider cross-sectional area. Flow through the orifice forces particles towards the flow axis, so that the aerosol stream is narrowed and collimated to provide the functional attributes of a lens. Aerosol streams collimated by an aerodynamic lens system have been designed for use in many fields, including pharmaceutical aerosol delivery and additive manufacturing. In the typical aerodynamic lens system, an aerosol stream is tightly confined around the axis of a flow cell by passing the particle distribution through a series of axisymmetric contractions and expansions. Each section of the lens system consisting of a flow channel and an orifice is defined as a stage. Liu has presented a method and apparatus for focusing sub-micron particles using an aerodynamic lens system. Di Fonzo et. al. and Dong et al. have designed lens systems that focused particles with diameters in the range from 10 to 100 nanometers and 10 to 200 nanometers, respectively. Di Fonzo, F., Gidwani, A., Fan, M. H., Neumann, D., Iordanoglou, D. I., Heberlein, J. V. R., McMurry, P. H., Girshick, S. L., Tymiak, N., Gerberich, W. W., and Rao, N. P., “Focused nanoparticle-beam deposition of patterned microstructures,” Appl. Phys. Lett. 77(6), 910 (2000). Dong, Y., Bapat, A., S. Hilchie, U. Kortshagen and S. Campbell, “Generation of nano-sized free standing single crystal silicon particles”, Journal of Vacuum Science & Technology B: Microelectronics and Nanometer Structures Processing, Measurement, and Phenomena 22, 1923 (2004).

Wang has designed a lens system to focus particles in the range of 3 to 30 nanometers. Lee has reported a method of focusing micron-sized particles at atmospheric pressures using a single lens system composed of multiple stages. Lee, J-W, et. al. “Inertial focusing of particles with an aerodynamic lens in the atmospheric pressure range”, Aerosol Science 34 (2003) 211-224.

In U.S. Pat. No. 6,348,687, Brockmann discloses an apparatus for generating a collimated aerosol beam of particles with diameters from 1 to 100 microns. The aerodynamic lens system of Brockmann uses a series of fixed lenes and an annular sheath gas surrounding a particle-laden transport gas. The system of Brockmann was used to focus 15-micron aluminum particles to a diameter of 800 microns, and generally uses the same aerosol and sheath gas flow rates. In U.S. Pat. No. 7,652,247, Lee discloses an aerodynamic lens system for focusing nanoparticles in air with diameters between 5 and 50 nanometers. In U.S. Pat. No. 8,119,977, Lee discloses a multi-stage, multi-orifice aerodynamic lens for focusing a range of particle diameters covering two orders of magnitude, from 30 to 3000 nanometers. In U.S. Pat. No. 6,924,004, Rao discloses a method and apparatus for depositing films and coatings from a nanoparticle stream focused using an aerodynamic lens system. The apparatus of Rao uses high-speed impaction to deposit nanoparticles on a substrate. A method of separating particles from a gas flow using successive expansions and compressions of the flow created by an aerodynamic lens is discussed by Novosselov in U.S. Pat. No. 8,561,486.

Hydrodynamic focusing using a sheath gas is generally accomplished by propagating an annular sheath/aerosol flow through a continuously converging nozzle, using differing sheath and aerosol gas flow rates. The degree of focusing is proportional to the ratio of the gas flows. In U.S. Pat. No. 7,108,894, Renn discloses a method of particle focusing using a coaxial sheath gas flow that surrounds an aerosol-laden transport gas. The combined flow is then propagated through a converging nozzle. Renn teaches that for the operational range of a flow system using a sheathed aerosol stream and a single converging nozzle, the diameter of the focused beam is a strong function of the ratio of the sheath to aerosol gas flow rates.

Focusing of a stream of aerosol particles using a system of aerodynamic lenses was first reported by Liu as cited above. The system of Liu was used to narrow and collimate a beam of spherical particles with diameters of approximately 25 to 250 nanometers. Liu used a lens system having three to five stages, with emphasis placed on achieving a low pressure drop across each lens. Numerous experimental and theoretical studies have been performed after the work of Liu, considering the aerodynamic effects of single and multi-orifice lens configurations.

Many researchers have reported studies of aerodynamic focusing of aerosol streams using fixed multi-stage lens systems (Lee, Brockmann, and Liu). Lee discloses an aerodynamic lens for focusing nanoparticles with diameters ranging from 30 to 3000 nanometers. Brockmann describes a multi-stage lens system that focuses large, solid particles. The prior art Brockmann apparatus also uses an annularly flowing sheath gas to prevent impaction of particles onto the orifice surfaces. The prior art apparatus of Brockmann propagates a sheath gas flow through the entire multi-stage lens system. Liu has disclosed an apparatus for focusing nanoparticles using an aerodynamic system consisting of three stages to five stages.

Sheath gas flows are frequently used to focus fluid flows. In the case of an aerosol stream flowing through a lens or a series of lenses, the addition of a sheath gas augments the aerodynamic focusing effect of the lenses by occupying some fraction of the cross-sectional area of the lens orifice, in effect stretching the aerosol flow through the orifice so that a decrease in the aerosol beam diameter is achieved. The effect of the sheath is therefore to produce hydrodynamic focusing of the aerosol stream over a broad range of droplet diameters.

In aerosol printing applications, aerosol droplets with diameters ranging from approximately 0.5 to 5 microns are typically produced by various aerosolization methods. The most common aerosolization methods used in the art of aerosol printing are pneumatic aerosolization and ultrasonic aerosolization. Ultrasonic aerosolization produces a droplet diameter distribution that requires a series of aerodynamic lens for optimal focusing. In a common use of ultrasonic aerosolization, a 1.6 MHz transducer frequency produces droplets with a medium diameter of approximately 3 microns. Droplets with diameters as small as 0.5 and as large as 5 microns can be produced using a 1.6 MHz transducer frequency, so that a multi-lens aerodynamic focusing assembly is needed to perform high-definition printing.

In Filament Extension Atomization (FEA) an ink is flowed between two smooth counter-rotating surfaces, creating a filament that is stretched until breakup occurs. Other embodiments of FEA are also applicable to aerosol-based printing. The resulting aerosol can be nearly monodispersed and can be transported to a flow cell and focused for use in aerosol jet printing applications. The FEA process can be tuned to provide the optimum droplet size distribution for a specific aerodynamic lens assembly, or for a single aerodynamic lens.

In electrospray atomization an electric field is used to pull droplets from a fluid meniscus formed between a nozzle with a pendant emerging fluid and a charging plate. A relatively narrow droplet diameter is produced in the electrospray aerosolization technique so that tight focusing of an aerosol can be accomplished using two aerodynamic lenses. An ionization source is typically used to remove charge from the droplets prior to the focusing step.

In vibrating mesh aerosolization a liquid sample is placed above a mesh composed of small holes. A piezoelectric element forces the mesh to vibrate vertically, so that fluid is entrained and emitted from the mesh. Vibrating mesh aerosolization can produce an aerosol distribution with a relatively small diameter dispersion. Vibrating mesh nebulizers produce droplets with diameters in the range of approximately 1 to 5 microns.

The ability to focus a droplet entrained in a gas stream is related to the Stokes number, St, of the droplet. It is generally accepted that optimum focusing of an aerosol is obtained when St is equal to unity. Unfocused droplets can be generally categorized as overspray or satellite deposition. Overspray deposition occurs when small droplets pass through the lens assembly with a small Stokes number without achieving a Stokes number near unity at any stage of the assembly. Satellite droplets are conversely generated when large droplets pass through each stage of the assembly with Stokes number much greater than unity.

The droplet Stokes number is dependent on the droplet mass, droplet diameter, aerodynamic lens diameter, and gas flow rate through the lens. A single-lens focusing system cannot provide focusing of droplet diameters that vary over an order of magnitude. While the use of multi-lens focusing assemblies has been reported, droplets in the range of approximately 0.5 to 1.0 microns are difficult to focus. Small droplets, roughly defined as droplets with diameter less than 700 nm, are particularly problematic in aerosol focusing. While it is possible to vary the flow rate and lens diameter to achieve a Stokes number of unity for small droplets, in practice configurations and parameters that produce a Stokes number of one for small droplets are invariably prone to clogging, and are not suitable for reliable, production-level applications.

Previous attempts in aerosol printing to improve focusing of micron and sub-micron size droplets have used methods involving the addition of solvent vapor in transport and sheath gas flows, or methods employing multi-lens focusing assemblies. Neither method, however, can singularly provide a viable solution suitable for high-accuracy or high-volume production applications. Indeed, the aerodynamic lens diameters and gas flow rates required to focus the smallest aerosol droplets in the distribution, that is, lens diameters and flow rates that yield a Stokes number of 1, are prone to the development of non-laminar flow that produces clogging. It is therefore essential for any method of producing high-definition printing to begin with a suitable droplet diameter distribution that is maintained throughout the transport and focusing processes.

In general, optimum focusing of an aerodynamic lens is obtained for droplet and flow parameters that yield a Stokes number of 1. The Stokes number is related to the particle diameter and the orifice diameter according to equation 1;

$$St = ( \frac{ρ {d}^{2} C}{18 μ} ) \frac{U}{D} \qquad ( 1 )$$

where □ is the particle density, d the particle diameter, C is the slip correction factor, □ is the gas dynamic viscosity, U is the gas velocity at the orifice, and D is the orifice diameter. The slip correction factor is calculated to be approximately 1. In the case of a sheathed flow, the gas velocity is taken to be the sum of the sheath and transport gas velocities.

Prior art attempts at aerosol-based printing have met with limited success in part owing to the frequent requirements for servicing due to clogs. As a result, reliable manufacturing-scale reproduction has been hampered by limited throughput and lack of maintenance of reproducible tolerances. One source of the need for service has been solvent vapor condensation that produces fluid accumulation along the flow path and in particular at the gas input, the aerosol output, and combinations of both. Prior art attempts at aerosol-based printing are also limited in terms of their ability to create uniform drop sizes, which is an important parameter for the achievable density of printing onto a substrate.

Thus, there exists a need for a print head for an aerosol-based printing apparatus that enhances aerosol transport time through the print head to reduce the time the aerosol ink lingers within the print head. There further exists a need for a print head for an aerosol-based printing apparatus enhances the accuracy of the uniformity of the droplets produced by the print head and that reduces the residual printed aerosol from a shutter of the print head.

### SUMMARY OF THE INVENTION

The present invention provides an aerosol-based printing apparatus that includes a print head, an ink cartridge, and a temperature regulation element. According to embodiments, the print head includes a housing; an aerosol channel defined in the housing, the aerosol channel having an inlet and configured for an aerosol gas to pass therethrough; an aerosol feed channel defined in the housing, the aerosol feed channel in fluid communication with the aerosol channel; a valve in fluid communication with the aerosol channel and the aerosol feed channel, the valve configured to control the fluid communication of the aerosol gas between the aerosol channel and the aerosol feed channel; a sheath channel defined in the housing, the sheath channel configured for a sheath gas to pass therethrough, the sheath channel having an inverted U-shaped passage portion that is configured to change a flow direction of the sheath gas; and a combination chamber defined in the housing at an output of the sheath channel and an output of the aerosol feed channel, in which the sheath gas impinges onto the aerosol gas to focus the aerosol gas. In the print head, the sheath gas is configured to first flow upwards within the inverted U-shaped portion of the sheath channel and the sheath gas impinges onto the aerosol gas at an acute angle.

The ink cartridge of the printing apparatus includes a housing defining an internal volume positioned above a liquid ink vial, the internal volume of the ink cartridge having an outlet that is configured to be in fluid communication with the inlet of the aerosol channel of the print head. The internal volume of the ink cartridge is divided into two regions by a cylindrical cap that defines a plurality of apertures in a wall thereof and a plurality of inwardly extending C-shaped shields disposed at each of the plurality of apertures that are configured to block the passing of large droplets of ink out of the cap, particularly on startup of the printing apparatus.

### BRIEF DESCRIPTION OF THE DRAWINGS

The present invention is further detailed with respect to the following drawings that are intended to show certain aspects of the present invention but should not be construed as a limit on the practice of the present invention.

FIG. 1A Shows a perspective view of an inventive printing apparatus.

FIG. 1B shows a cross-sectional perspective view of an inventive printing apparatus according to embodiments of the present invention;

FIG. 1C shows a detailed view of encircled area 1B shown in FIG. 1A;

FIG. 1D is a cross-sectional view of the inventive printing apparatus of FIG. 1A;

FIG. 1E is a cross sectional view of a focusing assembly of the printing apparatus of FIG. 1A and shows the sheath gas and aerosol laden gas flow in the left portion of the flow passages only;

FIG. 1F is a detailed cross-sectional view of the region where the aerosol laden gas stream and sheath gas flow streams are merged at the combination chamber of the focusing assembly of FIG. 1E;

FIG. 1G is a detailed cross-sectional view of as the collimated stream of particles flows through a first stage flow channel and into a second focusing stage of the focusing assembly of FIG. 1E; and

FIG. 2 is a graph showing focusing of the an existing print head vs. the inventive print head at varying sheath gas flow rates

### DETAILED DESCRIPTION OF THE INVENTION

The present invention has utility as a print head for an aerosol-based printing apparatus capable of forming discreet patterns on a substrate using a multi-lens hydrodynamic focusing assembly. The inventive print head enables a high throughput in part by providing enhanced shuttering to avoid clogging. The inventive print head additionally provides a significantly reduced transport time for the aerosol within the print head as compared to existing solutions. The generation of an aerosol is a fundamental step in aerosol-based printing as is the focusing of aerosol particles. Consequently, the stability, reliability, and ease of use of any aerosol printer is heavily dependent on the method used to aerosolize the printed ink and the methods used to focus the ink. Embodiments of the present invention disclose a novel use of hydrodynamic focusing at a first focusing stage within the print head. The hydrodynamic focusing uses gas pressure or gas velocity differences between two gas flows to affect particle focusing. A benefit of hydrodynamic focusing over aerodynamic focusing is that flow restricting orifice that can lead to clogging can be eliminated. The generation and maintenance of an aerosol droplet distribution with diameters in the range of 0.5 to 8 microns is disclosed. Maintenance of the droplet diameter distribution is accomplished by the addition of solvent vapor or aerosolized solvent vapor droplets to the sheath or aerosol transport gas.

A significant improvement of the present disclosure over existing aerosol-based printing solutions is the reduced aerosol transport time through the print head. Existing solutions are not optimized for aerosol transport and typically require as much as 5 seconds for the aerosol input d to be transported to the point where the combined gas streams (aerosol and sheath) exit the first aerodynamic lens. In contrast, the inventive print head provides an aerosol transport time through the print head to the exit of the first aerodynamic lens that is approximately 30 to 100 ms. The c aerosol transport time is decreased by approximately 50 times that of an original print head design.

The inventive apparatus minimizes or eliminates overspray and satellite droplet deposition and solvent vapor condensation, and allows for continuous unassisted printing, with operating time limited only by the rate of ink consumption and the volume of ink loaded in the ink cartridge. In embodiments of the invention, a sheath gas is passed through a reservoir containing the ink solvent fluid, allowing for solvent evaporation into the gas as the gas flows above the surface of the fluid. The temperature of the vapor laden sheath gas is kept below the dew point of the solvent as the flow passes through the print module so that condensation is eliminated.

The present invention provides production, transport, and delivery of an uninterrupted aerosol stream at a constant rate for a period of time of more than 24 hours of continuous operation. The need for purge or cleaning cycles due to solvent vapor condensation in the aerosol and gas transport conduits is eliminated. By inhibiting bulging and necking of the deposited trace, superior line width tolerances are achieved. Embodiments of the inventive apparatus are able to maintain tight tolerances for extended periods of time, thereby allowing for both the deposition of complex traces as well as the consistent manufacture of duplicate articles that maintain tolerances during a production run.

Embodiments of the invention combine the use of aerodynamic and hydrodynamic focusing as well as aerosol production methods that produce a stable, reproducible aerosol distribution matched to a lens assembly for the purpose of printing high-resolution features with trace widths of 5 microns as well as spacing as small as 5 microns. Embodiments of the inventive apparatus produce and maintain a distribution of micron-size aerosol droplets that is matched to a sheathed assembly of aerodynamic lenses. The lens assembly has the capability to focus a matched distribution to a minimum spot size of between 0.5 and 8 microns, so that high-definition structures are printed without droplet defocusing. Maintenance of the matched distribution during transport from the aerosolization source to a focusing assembly is critical to printing high-definition traces, since droplet evaporation will result in detuning of the distribution. Maintenance of the droplet diameter distribution is accomplished in embodiments of the inventive apparatus by adding solvent vapor to an aerosol transport gas or to a sheath gas. It has been determined that use of a droplet distribution with diameters greater than 0.5 micron and less than 8 microns and an aerodynamic lens assembly matched to the distribution with hydrodynamic focusing is critical for high-definition printing. In still other embodiments, the droplet diameter range is greater than 1 micron and less than 6 microns.

Embodiments of invention produce a highly focused aerosol deposition by using multiple focusing lenses to more effectively focus smaller droplets with diameters between 0.5 and 1.5 microns. The addition of solvent vapor to the sheath gas flow minimizes evaporation of ink solvent so that the match between the droplet diameter distribution and the aerodynamic lens assembly is maintained.

Embodiments of the invention address the issue of focusing small droplets in ambient conditions by minimizing the production of droplets smaller than 0.5 microns. Embodiments of the current invention use ultrasonic excitation frequencies or other aerosolization techniques that produce droplets in the range of 0.5 to 8 microns. In inventive embodiments, no small, difficult to focus droplets are present in the aerosol stream, and larger droplets are easily focused with aerodynamic lenses and hydrodynamic focusing.

In embodiments of the invention the aerosol may be produced from a liquid using various aerosolization methods. The liquid may be a nanoparticle suspension in a solvent, or a solute dissolved in a suitable solution. In embodiments of the invention low-vapor pressure inks and aerosolization methods produce an aerosol droplet diameter distribution that is matched to the aerodynamic lens system of the printer. In a specific embodiment of the invention, d-limonene is used as a suspending medium for nanoparticle inks, enabling the production of a stable aerosol distribution with droplet diameters in the range of 2 to 4 microns. Embodiments of the inventive print head employ the use of an annular sheath flow surrounding an aerosol stream that propagates through an aerodynamic lens assembly matched to an aerosol droplet diameter distribution. The sheath flow provides hydrodynamic focusing of the aerosol-laden inner flow that is stretched and compressed by the outer flow. The amount of hydrodynamic focusing is proportional to the ratio of the total volume occupied by the sheath gas to that of the aerosol gas. The hydrodynamic focusing utilizes gas velocity/density differences between the sheath gas and the aerosol gas to affect focusing of the aerosol stream. According to embodiments, the hydrodynamic focusing is further enhanced by ensuring that the aerosol gas is a low-density gas source while the sheath gas is a higher density gas source, allowing the aerosol stream to be more tightly focused. Additional focusing of the aerosol stream is also accomplished through aerodynamic focusing, as the combined gas flows propagate through the lens assembly.

In another embodiment, the print head can use only hydrodynamic focusing to produce a tightly focused aerosol beam that is printable. Using hydrodynamic focusing for the first focusing stage provides a more tightly focused aerosol beam that can pass through the aerodynamic lens with a smaller diameter thus reducing the chance of particle impaction and subsequent clogging of the aerodynamic lens.

In the hydrodynamic focusing only embodiment, the second stage aerodynamic focusing lens is replaced with a second (or multiple) hydrodynamic focusing stage(s) before the focused aerosol stream exits the print head. The second hydrodynamic focusing stage uses the collimated aerosol beam exiting the first hydrodynamic focusing stage as the input to the second hydrodynamic focusing stage. The second hydrodynamic focusing stage can serve to further reduce the diameter of the collimated aerosol beam and/or increase the output particle velocity to increase the print capability. One advantage of using multiple hydrodynamic lenses is associated with improving long term print stability. The benefit of hydrodynamic focusing without aerodynamic focusing is that the flow restricting orifice associated with the aerodynamic lens can be eliminated are replaced with a focusing stage which has no restricting orifice. This can lead to improved print performance with increased operating times.

A second advantage of the hydrodynamic focusing only embodiment is that the higher particle velocities in the collimated aerosol beam will increase particle momentum allowing smaller particles to have sufficient momentum to be impacted out in the print area. The increase particle momentum in the smaller particles enhances the ability of the aerosol print head to use smaller diameter particles to print smaller features. The particle diameter can be a limiting factor in achievable printed line width.

As used herein optimum printing is defined as the minimum printed trace width and highest contrast trace edge definition that is achieved when the total gas flow rate, lens diameter, and droplet physical properties are matched to each stage of the aerodynamic lens assembly for a specific range of droplet diameters. The matched sheathed lens assembly used in embodiments of the invention is capable of printing with higher resolution than an unmatched system. It has been determined that an unmatched sheathed aerosol focusing assembly will produce partially focused traces with randomly deposited unfocused droplets.

Embodiments of the inventive print head produce discreet patterns by shuttering a continuous stream of aerosol particles using a pneumatic shutter. Uniquely, the present invention diverts the carrier gas flow and pauses the aerosol flow from the aerosol chamber to the aerosol exit orifice during the shuttering step. Pausing of the aerosol flow is combined with other means simultaneously to effectively stop the flow of aerosol into the flow cell.

One means used in conjunction with diverting of the aerosol gas flow through the aerosol chamber is the use of a mechanical shutter which physically prevents the aerosol from entering the aerosol exit orifice while the shutter is enabled. When the mechanical shutter is actuated, mechanical actuation applies a sudden pressure to the aerosol exit orifice to expel any remaining aerosol from the aerosol exit tube. The applied pressure provides the means to quickly expel the residual aerosol that remains in the aerosol exit tube in between the aerosol exit orifice and the region where the sheath and aerosol streams are combined in the flow cell. Expulsion of the residual aerosol is critical to rapidly stopping the print.

With the mechanical shutter, the sudden pressure can be created by a rubber diaphragm that contacts the surface surrounding the aerosol exit orifice to create a seal where there is a volume of gas trapped in between the diaphragm and the aerosol exit orifice. In one embodiment, the diaphragm is flexible (much like a household plunger) and as additional force is applied to the diaphragm, the gas trapped in between the diaphragm and the aerosol exit orifice is forced through the aerosol exit orifice. This causes the residual aerosol in the aerosol exit tube to be expelled and carried away by the sheath gas. In another embodiment, the diaphragm has a piston that extends into the aerosol exit orifice and into the aerosol exit tube. The piston displaces the volume within the aerosol exit tube to effectively expel any residual aerosol trapped in the aerosol exit tube.

A second means used in conjunction with diverting of the aerosol gas flow through the aerosol chamber is the use of a pneumatic actuator that serves to expel the residual aerosol from that remains in the aerosol exit tube in between the aerosol exit orifice and the region where the sheath and aerosol streams are combined in the flow cell. The pneumatic actuator opens an orifice to the aerosol chamber momentarily to reduce the pressure within the aerosol chamber and simultaneously allows the sheath gas to flow through the aerosol exit tube in between the aerosol exit orifice and the region where the sheath and aerosol streams are combined in the flow cell into the aerosol chamber effectively expelling the residual aerosol from the aerosol exit tube. There are other methods that can be used, but the important aspect for fast shuttering is to expel the residual aerosol that remains in the aerosol exit tube when the shutter is actuated.

These internal shutters provide for efficient shuttering of the aerosol stream. Efficient shuttering of the aerosol stream is defined as a complete and sudden interruption of aerosol flow from the dispense nozzle in less than approximately 250 milliseconds, wherein no aerosol flow from the dispense tip is produced until the shutter is deactivated and gas flow through the print head is re-established. Embodiments of the invention are capable of printing features as small as 4 microns and as large as approximately 500 microns, at shuttering speeds typically between 10 and 250 milliseconds. It is appreciated that large features can be produced by contiguous passes of a given width thereby making for feature widths over at least two orders of magnitude.

Embodiments of the invention minimize the time required to transport aerosol droplets from an atomizer aerosol exit orifice to the point where the aerosol flow combines with the sheath gas flow in the flow cell. This is accomplished by minimizing the length of the aerosol exit tube in between the aerosol chamber and flow cell. Typically, the sheath gas flow is much larger than the aerosol gas flow rate and so minimizing the aerosol transport distance is essential for fast shutter actuation.

Embodiments of the invention minimize the time required to transport aerosol droplets from the atomizer chamber output port to aerosol exit orifice by ensuring that the aerosol can continuously replenish the aerosol in region in between the atomizer chamber output port and the aerosol exit orifice. The aerosol has fluid-like properties and the ability to flow into a region is limited by the geometry of the feature where the aerosol will flow. For example, if the aerosol is expected to flow from a tube where the aerosol entrance to the tube is at a low point and the end where the aerosol will flow out from is a high point, if the bottom of the tube exit is above the top of the tube entrance, the aerosol will only fill the tube to the level of the top of the tube entrance. In this case, the aerosol will not free flow from the tube. If, however, the bottom of the tube exit is below the top of the tube entrance, the aerosol will free flow from the tube with the top of the aerosol stream being limited by the height set by the top of the tube entrance. In this embodiment, it is important to have the top of the communication channel configured such that the top of the communication channel input from the aerosol chamber is higher than the aerosol exit orifice. This will minimize any delay time required to fill this region in between the atomizer chamber output port to aerosol exit orifice with aerosol since the aerosol can free flow from the aerosol chamber to the aerosol exit orifice. With the aerosol positioned at or near the aerosol exit orifice the time required to re-establish aerosol flow to a substrate is minimized, and shuttering times are reduced to less than 50 milliseconds.

Another aspect of the invention that is useful for all designs is related to the symmetry requirements for all orifices and channels in the print head. An orifice that is not centered on the flow cell axis will lead to asymmetric printing at the output. Another aspect of the present invention is that multiple chambers for the aerosol are provided in order to enhance print stability. The use of two separate chambers provides for suppression of pressure fluctuations, leading to a highly stable aerosol source.

In this embodiment, it is important to have good separation from the region where the aerosol is generated and the region in between the aerosol generation region and the entrance port to the communication channel. The aerosol prior to entering the aerosol communication channel must form a stable aerosol cloud. A large droplet passing through the aerosol cloud can create a boat-like wake that can cause the aerosol density in the aerosol cloud to be briefly disturbed and this brief disturbance can lead to instability in the printing. In this embodiment, an ultrasonic atomizer is used as the energy source to generate the aerosol for printing. A lower aerosol generation chamber is provided to contain the large droplets characteristic of ultrasonic aerosol generation. The lower aerosol generation chamber is covered with a lid which contains the large droplets within the lower aerosol generation chamber. The lid prevents splashing of the aerosolized fluid and enables the formation of a stable aerosol cloud. The lid includes a series of vents that prevent droplets from exiting the lower aerosol generation chamber but that do allow the aerosol from within the lower aerosol generation chamber to exit the lower aerosol generation chamber and fill the region between the outer surface of the lid and entrance to the aerosol communication channel. This embodiment meets the requirement for producing a stable cloud of aerosol without disturbance.

Temperature fluctuations of the ink can cause the aerosol output to vary significantly. The present embodiment includes a means to directly control the temperature of the print head. A thermoelectric device is integrated with the print head to ensure that the print head temperature remains constant during printing. Temperature fluctuations of the ink can cause the aerosol output to vary significantly. Control of the print head temperature provides the ability to minimize fluctuations in aerosol output that are related to temperature variations of the print head.

In another embodiment of the print head, a transducer is integrated into the print head to monitor and control the ultrasonic transducer output energy directly or indirectly.

A further embodiment includes the use of auxiliary reservoirs to maintain the fill level of various fluids. These fluids include the ink and the coupling fluid used to transmit the ultrasonic energy from the transducer to the ink. The levels of each of these fluids are important to stable operation of the print technology.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to specify all permutations, combinations, and variations thereof exhaustively.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only, and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

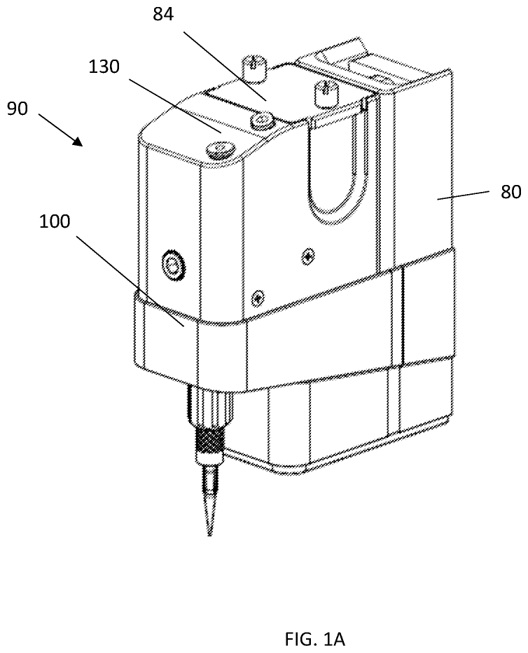

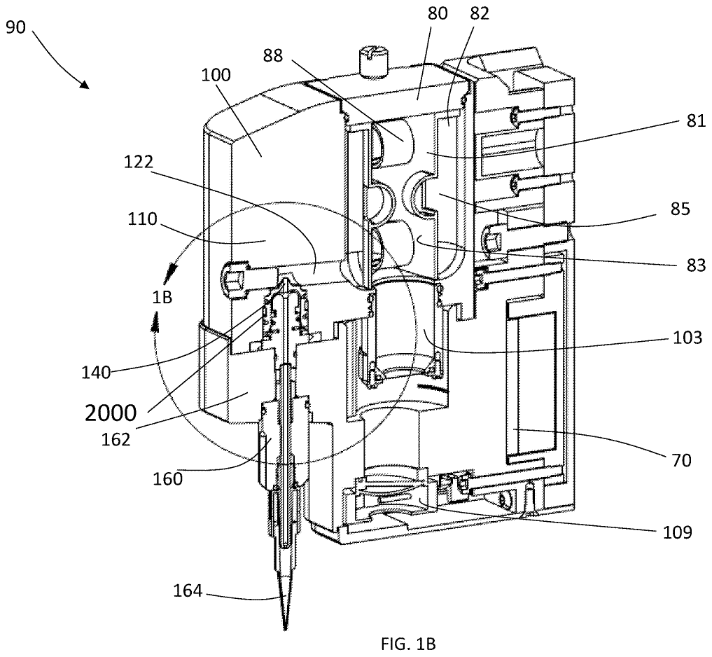

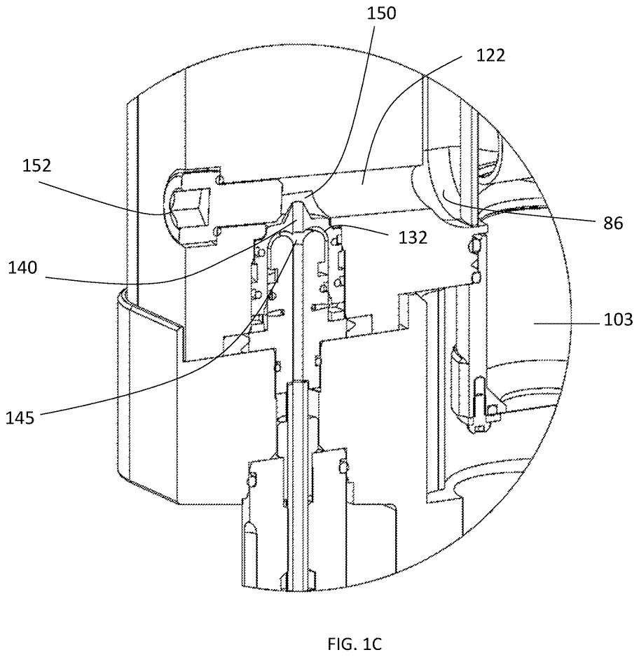

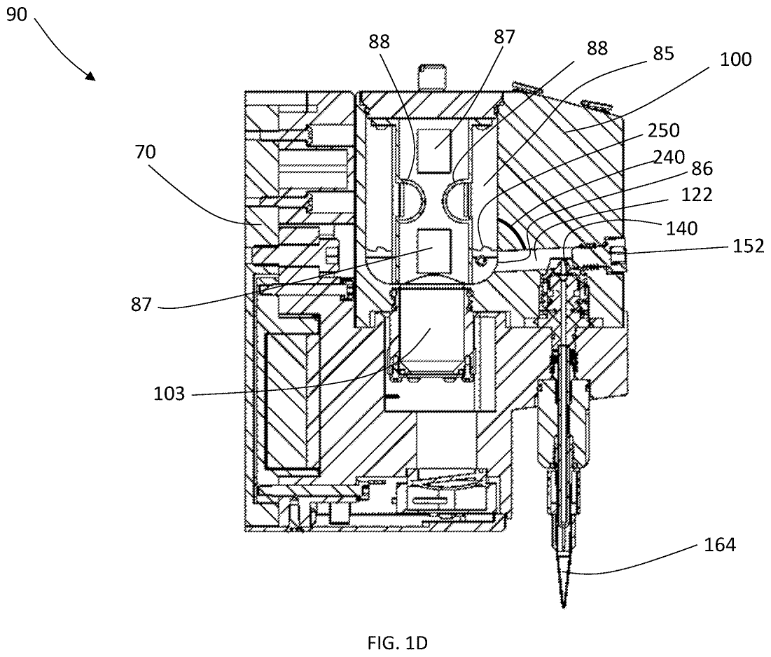

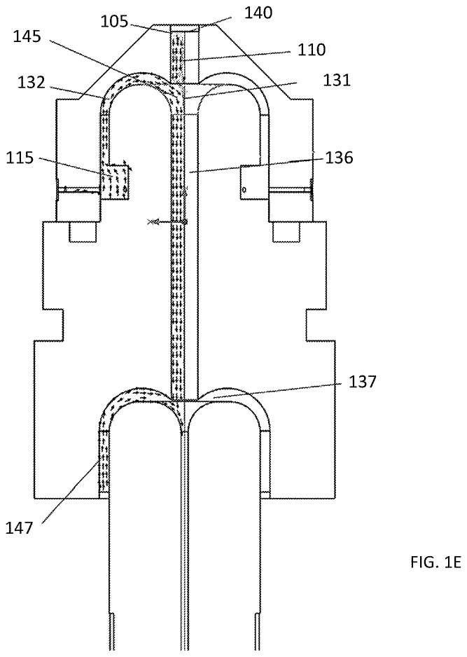

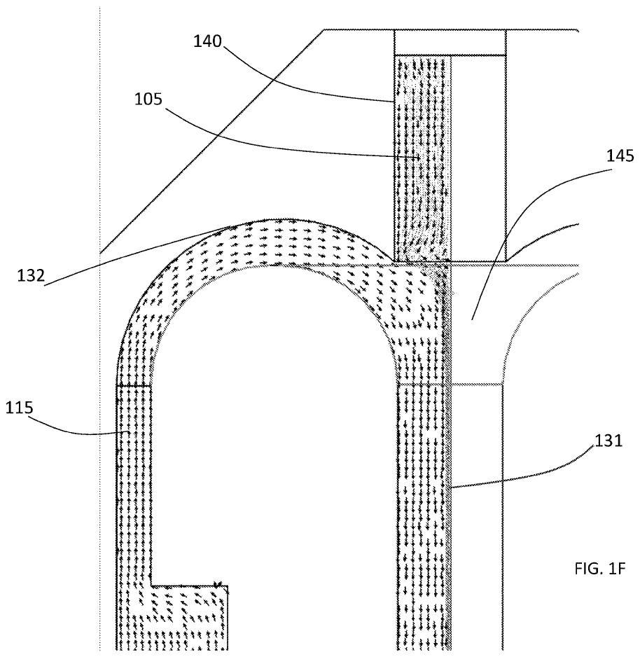

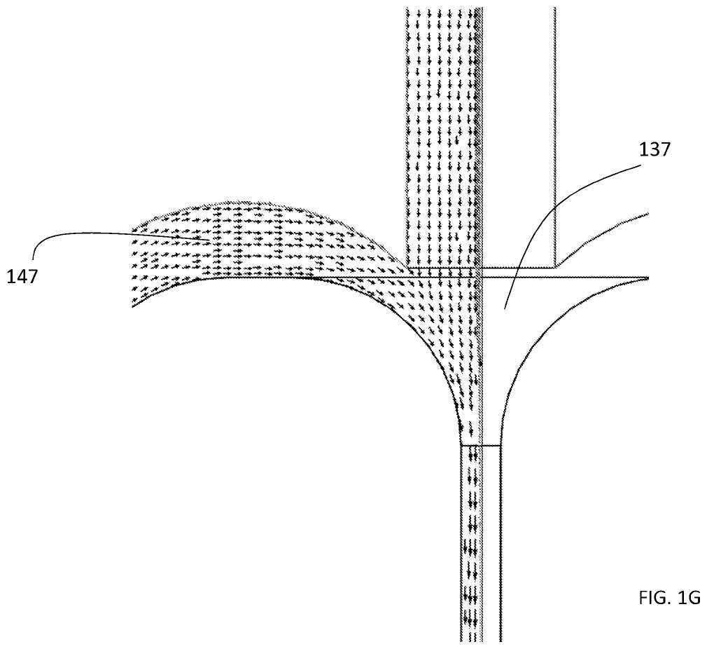

Embodiments of the present invention provide a NanoJet (NJ) print head 100 and an aerosol-based printing apparatus 90 for hydrodynamic printing. FIGS. 1A-1G show an embodiment of an inventive apparatus 90 and print head 100 according to the present invention. As best shown in the cross-sectional perspective view of FIG. 1A, the inventive printing apparatus 90 includes a printing head 100, an ink cartridge 80, and a temperature regulation element 70.

Referring to FIG. 1A, a carrier gas inlet 84 extends from outside the cartridge housing 80 into an internal volume within the cartridge housing 80 and a sheath gas input 130 extends from outside of the cartridge 80 into an internal volume within the cartridge housing 80.

As shown in FIG. 1B, embodiments of the inventive apparatus 90 include a cartridge 80 that defines an internal volume 82 which can be and generally is actively thermally controlled. A carrier gas inlet positioned outside the cartridge housing 80 is configured to be fluidly connected to a carrier gas source (not shown) and a second end of the carrier gas inlet is positioned in the internal volume 82 within the cartridge housing 80. According to embodiments, the carrier gas inlet extends through an upper wall of the cartridge housing 80. A sheath gas inlet positioned outside the cartridge housing 80 is configured to be fluidly connected to a sheath gas source (not shown) and a second end of the sheath gas inlet is positioned in the internal volume 2000 within the cartridge housing 80. According to embodiments, the carrier gas inlet extends through an upper wall of the cartridge housing 80.

The cartridge 80 includes an outlet port 86 positioned on a bottom end of the cartridge housing 80 through which an aerosol stream is output from the cartridge 80. As best seen in FIGS. 1B-1D, he cartridge 80 includes a liquid sample vial 103 positioned at the bottom end of the cartridge housing 80 that contains a nanoparticle ink. During printing, an ultrasonic atomizer 109 is used to produce a dense aerosol in the liquid sample vial 103. Without intending to be bound to a particular theory, the energetics of ultrasonic atomizer 109 create changes to the ink composition with the vial 103 that are manifest as changes in print line broadening over the time the contents of a vial are expended. Typically, the ultrasonic atomizer 109 operates at frequencies of 1.0 to 1.6 MHz. In some inventive embodiments, the temperature of the ink is held between 0° C. to 30° C. when not actively depositing ink nanoparticles onto a substrate.

Embodiments of the inventive cartridge 80 additionally include a cap 81 positioned within the internal volume 82 within the cartridge housing 80. The cap 81 is configured to divide the internal volume 82 within the cartridge housing 80 into two partially isolated regions 83, 85. Notably, the internal volume 82 within the cartridge 80 and the cap 81 are provided with inner diameters sufficient to preclude absorption of ultrasonic energy from an ultrasonic transducer and to preclude suppression of an ink spout. Other designs of cap 81 operative herein are detailed in US Patent Publication 2022/0088925. Notably, a first region 83 is generally centrally located within the internal volume 82 and is generally the largest of the regions. A second region 85 encircles the first region 83. The carrier gas inlet 84 may be positioned within either of the regions 83, 85 in the internal volume 82 within the cartridge housing 80. The cap 81 generally isolates the first region 83 from the second region 85 and isolates the carrier gas inlet 84 and aerosol outlet port 86 from pressure fluctuations in the aerosol chamber. The first region 83 is positioned above liquid sample vial 103 positioned at the bottom end of the cartridge housing 80 that contains a nanoparticle ink. As shown in FIGS. 1B and 1D, the cap 82 includes a plurality of apertures 87 in the wall thereof that allow fluid communication between the first central region 83 of the internal volume 82 and the second outer region 85 of the internal volume 82. At each of the apertures 87 is a C shaped shield 88 that shield the apertures 87 from large droplets of ink that are typically formed at start up of such printing apparatus 90, particularly when a carrier gas in first introduced to the volume 82 and first impinges on the ink in the liquid sample vial 103. Such initial impingement typically causes large droplets (approximately 1 mm) of ink to splash up from the surface of the ink, which are likely to cause clogs within the print apparatus 90 if not blocked. Hence, the shields 88 act to prevent the large ink droplets from getting out of the first region 83 of the internal volume 82 of the cartridge 80, while the openings in the sides of the C-shaped shields 88 allow aerosolized ink in the carrier gas to exit the first region 83 and pass into the second region 85 and subsequently on to the print head 100, as will be explained below.

In use, an ultrasonic atomizer 109 is used to produce a dense aerosol in the liquid sample vial 103. An aerosol cloud expands into and fills the first region 83 of the internal volume 82 of the cartridge 80. A dry or vapor-laden carrier gas enters the cartridge 80 through carrier gas inlet 84. The downwards facing orientation of the carrier gas inlet 84 forces gas to flow from the second end thereof over the shields 88 and across the surface of the sample in the sample vial 103, so that aerosol is entrained in the gas flow and then into the first isolated region 83. An aerosol-laden carrier gas then enters the second region 85 by passing through the apertures 87 shielded by the C-shaped shields 88 and exits the cartridge 80 via the outlet port 86. The aerosol-laden flow propagates along an aerosol channel 122 of the print head 100.

As shown in FIG. 1D, the aerosol in the internal volume 82 of the cartridge housing 80 is transported to the aerosol outlet port 86 to allow the aerosol laden gas to flow through the aerosol channel 122 to the aerosol feed channel 140 to provide the aerosol source for printing. Since the aerosol laden gas has fluid-like properties it is important that the combination of the diameter of the aerosol channel 122 and the angle 240 of the aerosol channel 122 allow the top of the fluid level point 250 to be above the aerosol outlet port 86 in order to provide a ready source of aerosol for printing. When the aerosol is kept at a level 250 above the aerosol outlet port 86, the aerosol can quickly leave the internal volume 82 of the aerosol chamber within the cartridge housing 80 and provide a feed source for aerosol printing.

In another inventive embodiment, used in place of, or in concert with ultrasonic transducer, ultrasonic atomizer 109 is operated absent gas flow from the carrier gas inlet 84. The resulting agitation of the nanoparticle ink while not actively depositing ink onto a substrate inhibits settling of nanoparticulate in the ink as manifest by improved aerosol output stability as the vial 103 is depleted of ink contents. In still other embodiments, the carrier gas inlet 84 is operated as a bubbler without the ultrasonic atomizer 109 being energized to agitate the nanoparticle ink. In some embodiments, the outlet port 86 is closed to inhibit evaporation. In still other embodiments, the distance between the end of the carrier gas inlet 84 is reduced to facilitate agitation of the ink, without regard to whether the tip of the carrier gas inlet 84 is below the meniscus of the nanoparticle ink in the vial 103. In some inventive embodiments, the temperature of the ink is held between 0° C. to 30° C. when not actively depositing ink nanoparticles onto a substrate. In still other embodiments, the ultrasonic atomizer 109 position relative to a level of ink the vial 103 is adjustable. It is noted that maintaining distance between the surface of ink in vial 103 is one method to agitate the nanoparticle ink. The position of the ultrasonic atomizer 109 is readily controlled by conventional techniques that include a float, or a distance sensor and a motor; such as a micromotor, stepper motor, or a servo motor. For visual clarity, these conventional components for distance control are not depicted in FIG. 1B. In still other operational modes, the ultrasonic atomizer 109 output is pulsed at various intervals and strengths to account for a given set of ink conditions as to composition and ink level, independent of whether the ultrasonic atomizer 109 is movable.

In still other embodiments, a stirrer is provided in the vial 103. The stirrer is provided in the form of a ball bearing, impeller, or a stir bar. The stirrer is readily driven by conventional inputs that illustratively include mechanical vibration, carrier gas flow, or a rotary magnetic field.

It is appreciated that nanoparticle ink stabilization when not depositing on a substrate is also readily accomplished with resort to temperature. In some embodiments, the ink is cooling from a printing temperature of from 15 to 30 degrees Celsius to from 0 to 10 degrees Celsius. Without intending to be bound to a particular theory, the reduced ink temperature when not printing can reduce colloidal destabilization effects associated with energy inputs, either through acoustics energy inputs from either the ultrasonic atomizer 109, ultrasonic transducer, or mechanical agitation or bubbling. In still another embodiment, the ink in the vial 103 is frozen when not actively printing onto a substrate. The frozen solvent forms a matrix that can preclude agglomeration of nanoparticles therein. A cooling jacket is readily employed to control the temperature of ink in the vial 103.

To address a loss of ink printing precision associated with a dropping ink level in the vial 103, according to embodiments, an auxiliary ink reservoir is provided that is in fluid communication with the volume of the vial 103 via a conduit. As a result, the level, of the ink in the vial 103 is maintained over usage of the vial contents. As a result, the distance between the ultrasonic atomizer 109, the end of the carrier gas inlet 84, and the level are maintained as printing continues. According to embodiments, the inventive apparatus 90 additionally includes programmed coupling of fluid levels so as to adjust for decreases in ink level with differences in production rates and other features that will provide better computational control over the process as a whole thus resulting in longer print times between required service shutdowns.

The ultrasonic atomization process is affected by the rheology of the ink being atomized. Stability of the printed output can typically be increased by controlling the temperature of the ink during atomization. As shown in FIG. 1B, embodiments of the inventive apparatus 90 include a temperature regulation element 70. According to embodiments, the temperature regulation element 70 is a cold plate that is configured to attach to the print head 100 and/or cartridge 80 in order to regulate the temperature of the ink at an optimal level. According to embodiments, the temperature regulation element 70 is an aluminum block that utilizes thermal conduction to regulate the temperature of the ink in the cartridge 80. According to some embodiments, the temperature regulation element 70 is a heat exchanger or a heat pipe that extends into the ink vial 103 and is immersed in the volume of the ink contained therein to regulate the temperature thereof via heat exchange for ink temperature stabilization. In these embodiments, the temperature is controlled using a closed-loop controller. The controller accepts feedback from a temperature sensing device which is in direct contact with the ink or close nearby. Typically, the controller maintains ink temperature to within one degree Celsius. According to embodiments, the temperature regulation element 70 is a Peltier cooler with a thermocouple in direct contact with the ink in the vial 103 to regulate the temperature and viscosity of the ink so that variations in an ink volumetric flow rate is reduced to less than 5% over eight hours. According to embodiments, a Peltier module is used to remove heat generated by the atomizer from the ink. The Peltier module is mounted to the side of the thermally conductive ink reservoir. A heatsink such as a heat exchanger or convective heatsink is used to accept the heat pumped out of the ink. In another embodiment, the Peltier module is connected to the reservoir which holds the coupling fluid between the atomizer and the ink reservoir. The Peltier module pumps the heat out of the coupling fluid. Because the coupling fluid is in thermal contact with the ink reservoir, the heat is removed from the ink.

Embodiments of the present invention provide a print head 100 for aerosol-based direct printing of discrete patterns using a multi-lens aerodynamic focusing assembly and a material shuttering assembly that is internal to the print head 100 of the apparatus 80. The apparatus 80 of the invention produces discrete patterns by shuttering a continuous stream of aerosol particles using a pneumatic shutter. According to embodiments, the print head 100 includes a housing 110 that defines various regions and internal flow passages within the print head 100. That is, the print head 100 includes an aerosol gas input via the aerosol channel 122 and a sheath gas input 130 both of which extend from outside the housing 110 to internal to the housing 110. The aerosol gas input flows from the outlet port 86 of the cartridge 80 within an aerosol channel 122 that is internal to the housing 110 of the print head 100 and intersects with a vertical aerosol feed channel 140 within the housing 110 and that is controlled by a valve 150. In this configuration the sheath gas is introduced into the print head 100 via the sheath gas input 130 to be radially symmetric to the vertical aerosol feed channel 140. The sheath gas first travels upward in the print head 100 and through an inverted u-shaped passage 132 that slowly changes the direction of the sheath gas flow from upward to downward. Before the sheath gas flow is redirected completely downward, the sheath gas impinges onto the downward, vertical aerosol gas flow from the vertical aerosol feed channel 140 at an angle of approximately 30 degrees. This combination occurs in a combination chamber 145. The combined gas streams are eventually directed downward together. The impingement angle serves to squeeze the aerosol flow to the middle of the vertical flow path effectively collimating the aerosol stream to a small diameter. The sheath flow achieves a uniform annular flow velocity around the flow axis of the flow cell 160. Embodiments additionally provide increased cylindrical symmetry of the pressure distribution along the flow axis of a flow cell 160 as a result of uniform sheath flow. According to embodiments, the flow cell 160 and atomizer base 162 are maintained at a temperature higher than that of the sheath and aerosol gases. The combined sheath gas and aerosol gas then flows out of the print head 100 via a fluid dispense tip 164. The apparatus of FIGS. 1A-1F minimizes or eliminates overspray and satellite droplet deposition and allows for continuous unassisted printing, with operating time limited only by the rate of ink consumption and the volume of ink loaded in the ink cartridge. Embodiments of the present invention are capable of continuous unassisted printing for more than twenty-four hours without the need for purge or cleaning cycles.

According to embodiments, the sheath gas is introduced in the print head 100 just 3 mm below the aerosol mist feed point. Advantageously, the inventive print head 100 enhances the aerosol transport time through the print head 100. Existing solutions which are not optimized for aerosol transport time take approximately 4.5 seconds for the aerosol input to the top of the print head to be transported to the point where the combined gas streams (aerosol and sheath) exit the first aerodynamic lens. For the inventive print head 100, the aerosol transport time through the print head 100 to the exit of the first aerodynamic lens is calculated to be approximately 87 ms. This change in transport time is decreased by approximately 50 times that of the original print head design.

Another significant difference between the inventive print head 100 and existing print heads is how the aerosol and sheath gas flows are combined. According to embodiments of the inventive print head 100, the sheath gas is combined with the aerosol flow gas 3 mm below the vertical point of entry of the aerosol stream into the vertical gas flow path. While the sheath and aerosol gas flow streams are both laminar at the point where the two gas streams are combined, the sheath gas is introduced at an angle with respect to the vertical gas flow path such that the aerosol gas stream is forced to be squeezed into a tightly collimated stream just after the aerosol and sheath gas flows are combined.

FIG. 1E is a cross sectional view of the focusing assembly of the printing apparatus 90 of FIGS. 1B-1E that show the gas and aerosol behavior in the left portion of the flow passages only for clarity; however, it will be understood that the gas and aerosol behavior as well as the focusing are symmetrical about a central axis. As shown, the aerosol laden gas stream 105 is introduced in the focusing assembly at the aerosol feed channel 140 after the aerosol laden gas stream 105 exits the aerosol channel 122. The aerosol laden gas stream 105 flows into the focusing assembly and is combined with a sheath gas flow 115 in the region where both the aerosol laden gas stream and sheath gas 115 flow streams are merged at the combination chamber 145, which is shown in greater detail in FIG. 1F. Since the sheath gas 115 flow is much larger than the aerosol gas flow, combining the sheath and aerosol stream as close to the intersection of the aerosol channel 122 and the aerosol feed channel 140 provides additional motivation to move the aerosol stream 105 through the focusing assembly more quickly. This enhances the shuttering time and provides the ability to have very clean starts and stops when the printing is shuttered. The flow path for the sheath gas 115 within the u-shaped passage 132 brings the sheath gas 115 upward and gradually redirects the sheath gas 115 inward and downward in the region where both gas streams are combined at the combination chamber 145. The higher velocity of the sheath gas and inward direction in the region where both streams are combined forces the particle to form a tightly collimated stream of particles 131. Once the particles are collimated, the collimated stream of particles 131 flows through a first stage flow channel 136 and into a second focusing stage 137, which is shown in greater detail in FIG. 1G. The behavior in the second focusing stage 137 is similar to that in the first focusing stage. A second sheath gas 145 is input into a plenum which uniformly distributes the sheath gas 147 to further focus the collimated aerosol stream of particles 131. In this second focusing stage 137 the particles are more tightly focused into a collimate beam and the particle velocity is also increased. The increased particle velocity enhances the ability to print finer particles without overspray due to the increased momentum input to the particles.

The invention is capable of printing features from 4 to even larger than 500 microns at shuttering speeds as fast as 10 milliseconds.

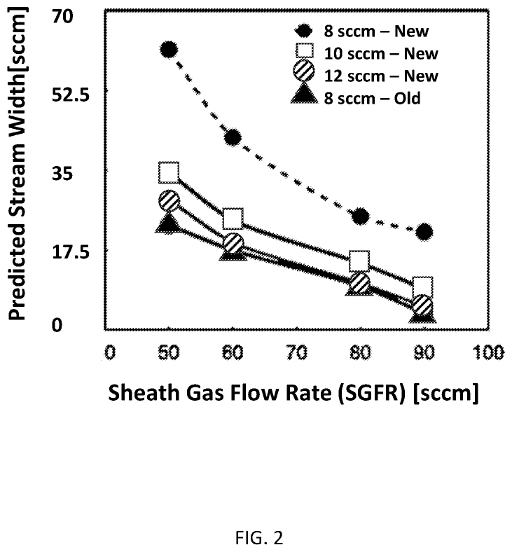

As shown in FIG. 2, the configuration of the present invention improves the focusing of the print head 100 as compared to existing aerosol based print heads. That is, the inventive print head 100 has better baseline focusing as compared to existing print heads for all sheath gas flow rates evaluated. The variation in focusing over the range of different sheath gas for the inventive print head 100 design is more linear as well in comparison to the existing print head design. Note that the droplets size used in the study shown was 2 μm.

According to embodiments, the inventive print head 100 includes a shutter to prevent leakage of residual aerosol. The shutter utilizes the valve 150 to stop aerosols from flowing downward through the vertical aerosol gas flow channel 140 to the print area as shown in FIGS. 1A-1GC. According to embodiments, an internal fully pneumatic shutter used in combination with a time delay relay, pneumatic valves, and a diverted aerosol flow to achieve shuttering of the aerosol stream. According to embodiments, the valve 150 is a pressure valve, as shown in FIGS. 1B-1D. According to such embodiments, a quick pressure pulse or vacuum pull, for example 10 ms, is applied to the aerosol channel 120 via a solenoid valve attached to the outlet 152 of the aerosol channel 122, as shown in FIGS. 1A-1D. This pressure pulse or vacuum pull on the channel 122 wicks any collected aerosol droplets off the surface of the channel 122. This is advantageous in that aerosol droplets tend to accumulate at the intersection of the aerosol channel 122 and the vertical aerosol feed channel 140 given the direction change in the flow path. The vent valve 150 of FIGS. 1A-1D is an important feature with a shuttering scheme that, without using a physical mechanism, diverts build up that could potentially cause a clog. These embodiments use a dynamic gas pulse with the pressure wave being sufficient to clear ink build on the walls before it can coalesce and clog up in this area. The duration of the dynamic gas pulse has a duration on the order of milliseconds. This shuttering method avoids problems of a mechanical needle valve that can still clog. The high speed pressure wave on the order of the millisecond closure speeds essentially sucks residual aerosol out of the tube. The geometry and timing are specific to the nature of the cartridge itself. According to embodiments, the valve is a needle valve or other proportional valve, According to another embodiment, the shutter is a plunger style valve that is used to stop the aerosol flow during non-printing moves. Notably, when the shutter is closed there remains some additional flow of aerosol from the print head. The total delay time to stop the aerosol flow is approximately 1.5 seconds. In observing the printed line after the shutter closed one could see that the majority of the aerosol is stopped rapidly, and that the remaining aerosol eventually stops. The amount of residual printed aerosol is heaviest when the shutter is first closed and eventually disappears over the 1.5 second time period. Without intending to be limited to a particular theory, this residual printed aerosol is believed to be related to the amount of aerosol captured in between the shutter valve and the point where the sheath and aerosol gases are combined. Error! Reference source not found.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. An aerosol-based printing apparatus comprising:
a print head comprising:
a housing;
an aerosol channel defined in the housing, the aerosol channel having an inlet and configured for an aerosol gas to pass therethrough;
an aerosol feed channel defined in the housing, the aerosol feed channel in fluid communication with the aerosol channel;
a valve in fluid communication with the aerosol channel and the aerosol feed channel, the valve configured to control the fluid communication of the aerosol gas between the aerosol channel and the aerosol feed channel;
a sheath channel defined in the housing, the sheath channel configured for a sheath gas to pass therethrough, the sheath channel having an inverted U-shaped passage portion that is configured to change a flow direction of the sheath gas; and
a combination chamber defined in the housing at an output of the sheath channel and an output of the aerosol feed channel, in which the sheath gas impinges onto the aerosol gas to focus the aerosol gas.

2. The printing apparatus of claim 1 wherein the aerosol feed channel of the print head is vertically oriented within the housing.

3. The printing apparatus of claim 1 wherein the valve of the print head is any one of a pneumatic valve, a plunger valve, a rotary valve, or a pressure valve.

4. The printing apparatus of claim 1 wherein the sheath gas is configured to first flow upwards within the inverted U-shaped portion of the sheath channel within the print head.

5. The printing apparatus of claim 1 wherein the sheath gas impinges onto the aerosol gas at an acute angle.

6. The printing apparatus of claim 1 wherein the sheath gas impinges onto the aerosol gas at an angle of 30 degrees.

7. The printing apparatus of claim 1 wherein the sheath gas is configured to surround the aerosol gas within the combination chamber of the print head.

8. The printing apparatus of claim 1 wherein an input of the combination chamber where the sheath gas impinges onto the aerosol gas is positioned less than 5 mm below a point where the aerosol gas enters the aerosol feed channel from the aerosol channel.

9. The printing apparatus of claim 1 wherein at least one of the aerosol gas and the sheath gas has a laminar flow within the print head.

10. (canceled)

11. The printing apparatus of claim 1 wherein the sheath gas is a higher density gas than the aerosol gas.

12. The printing apparatus of claim 1 further comprising at least one aerodynamic lens configured to receive the aerosol gas surrounded by sheath gas and to print a plurality of aerosol droplets onto a substrate.

13. The printing apparatus of claim 12 wherein said at least one aerodynamic lens is two or three lenses that vary in orifice diameter from one another.

14. The printing apparatus of claim 1 wherein the printing apparatus is configured to print high-resolution features with trace widths of 5 microns.

15. The printing apparatus of claim 1 wherein the printing apparatus is configured to print high-resolution features with spacing as small as 5 microns.

16. The printing apparatus of claim 1 wherein the print head achieves shuttering times of less than 50 milliseconds.

17. The printing apparatus of claim 1 wherein the aerosol chamber is vented for a controlled duration between 1 millisecond and 1 second to reduce residual printed aerosol.

18. The printing apparatus of claim 1 wherein the resolution of printing is 5 micron lines or greater separated by 5 micron gaps.

19. The printing apparatus of claim 1 further comprising an ink cartridge defining an internal volume positioned above a liquid ink vial, the internal volume of the ink cartridge having an outlet that is configured to be in fluid communication with the inlet of the aerosol channel of the print head.

20. (canceled)

21. (canceled)

22. The printing apparatus of claim 1 wherein the ink or the printhead housing is controlled between 0 Celsius and 50 Celsius using thermoelectric cooling or heat exchange.

23. (canceled)

24. The printing apparatus of claim 1 wherein a second combination chamber is added in which a second sheath gas impinges onto the sheathed aerosol flow to further focus the aerosol gas.
